(19) United States
(12) Patent Application Publication
(10) Pub. No.: US 2020/0180269 A1
(43) Pub. Date: Jun. 11, 2020

(54) METHOD FOR MAKING GRAPHENE ADHESIVE FILM AND METHOD FOR TRANSFERRING GRAPHENE

(71) Applicants: Tsinghua University, Beijing (CN); HON HAI PRECISION INDUSTRY CO., LTD., New Taipei (TW)

(72) Inventors: TIAN-FU ZHANG, Beijing (CN); ZHONG-ZHENG HUANG, Beijing (CN); XIAO-YANG XIAO, Beijing (CN); YING-CHENG WANG, Beijing (CN); QUN-QING LI, Beijing (CN); SHOU-SHAN FAN, Beijing (CN)

(21) Appl. No.: 16/299,989

(22) Filed: Mar. 12, 2019

(30) Foreign Application Priority Data
Dec. 6, 2018 (CN) 201811486144.7

(51) Int. Cl. B32B 9/00; B32B 15/082; B32B 7/12; C01B 32/184

(52) U.S. Cl. CPC B32B 9/007; C01B 32/184; B32B 7/12; B32B 15/082

(57) ABSTRACT

A method for making a graphene adhesive film includes the following steps: growing a graphene on a growth substrate, wherein the material of the growth substrate is copper; depositing an adhesive layer on a surface of the graphene away from the growth substrate, to form an adhesive/graphene/growth substrate composite structure; and removing the growth substrate from the adhesive/graphene/growth substrate composite structure with an etching solution, wherein the etching solution is a mixture of hydrogen peroxide, hydrochloric acid, and deionized water.

### FIELD

The present application relates to a method for making a graphene adhesive film and a method for transferring graphene.

### BACKGROUND

The graphene can be prepared by mechanical stripping method, silicon carbide epitaxial growth method, oxidation reduction method, chemical vapor deposition (CVD) method and the like. The CVD method for making the graphene are widely used because the graphene made by the CVD method are uniform, covers large areas, and of high quality.

The method for transferring the graphene from a copper growth substrate to a target substrate usually comprises: providing a support such as polymethylmethacrylate (PMMA) sheet or thermal release tape; etching the copper growth substrate with a ferric chloride solution or a ferric nitrate solution; transferring the graphene and the support to the target substrate; removing the support. However, in the process of etching copper growth substrate by the ferric chloride solution or the ferric nitrate solution, iron ions are oxidized into iron oxide particles, copper is also oxidized into copper oxide particles, and the iron oxide particles and the copper oxide particles can contaminate the graphene, thereby affecting the performance of the graphene.

Liang et al. (Toward Clean and Crackless Transfer of Graphene, ACS NANO, Vol. 5, No. 11, 9144-9153, 2011) discloses a method for washing a PMMA/graphene composite layer that is formed by etching the copper growth substrate with the ferric nitrate solution. The method includes: step 1, washing with deionized water; step 2, etching with a SC-2 solution for 15 minutes; step 3, washing with deionized water; step 4, etching with a SC-1 solution for 15 minutes; and step 5, washing with deionized water. The SC-2 solution is a mixture of deionized water, hydrogen peroxide and hydrochloric acid, and H₂O:H₂O₂:HCL (volume ratio)=20:1:1. The SC-1 solution is a mixture of deionized water, hydrogen peroxide and aqueous ammonia, and H₂O:H₂O₂:NH₄OH (volume ratio)=20:1:1. However, Liang et al. uses the conventional solution (iron nitrate solution) to etch the copper growth substrate, wherein the conventional solution caused contamination of the graphene during etching the copper growth substrate.

Therefore, there is room for improvement in the art.

### BRIEF DESCRIPTION OF THE DRAWINGS

Implementations of the present technology will now be described, by way of embodiments, with reference to the attached figures, wherein:

FIG. 1 is a process flow of a first embodiment of a method for making a graphene adhesive film.

FIG. 2 shows an optical image of the first embodiment of an etching solution.

FIG. 3 shows an optical image of the first embodiment of another etching solution.

FIG. 4 shows an optical image of the first embodiment of the graphene/adhesive composite structure.

FIG. 5 is a process flow of the first embodiment of a method for removing a growth substrate with the etching solution.

FIG. 6 is a process flow of a second embodiment of a method for transferring a graphene.

FIG. 7 shows an optical image of the second embodiment of the graphene after etching with a ferric chloride solution.

FIG. 8 shows a scanning electron microscope (SEM) image of the second embodiment of the graphene after etching with the ferric chloride solution.

FIG. 9 shows an optical image of the second embodiment of the graphene after etching with a mixture of hydrogen peroxide, hydrochloric acid, and deionized water.

FIG. 10 shows an SEM image of the second embodiment of the graphene after etching with the mixture of hydrogen peroxide, hydrochloric acid, and deionized water.

FIG. 11 shows a Raman spectrum of the second embodiment of the graphene after etching with the mixture of hydrogen peroxide, hydrochloric acid, and deionized water.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

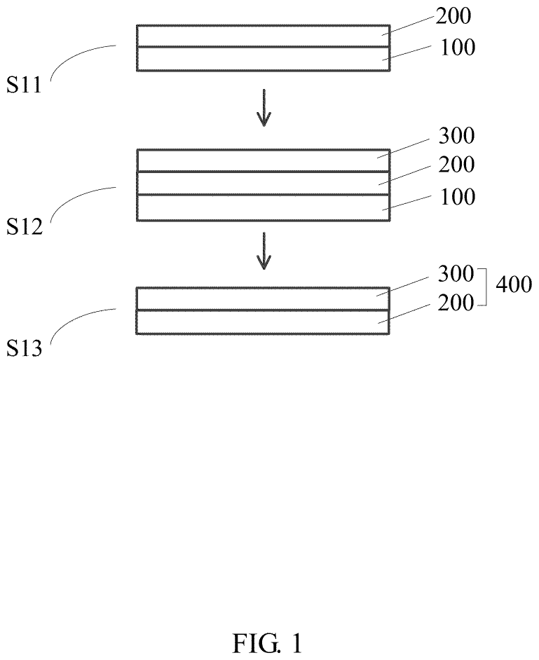

FIG. 1 to FIG. 5 show a method for making a graphene adhesive film 400 of a first embodiment, and the method includes one or more of the following steps:

S11, growing a graphene 200 on a growth substrate 100;

S12, placing an adhesive layer 300 on a surface of the graphene 200 away from the growth substrate 100; and

S13, removing the growth substrate 100 with an etching solution 600.

During step S11, the material of the growth substrate 100 is copper. The size of the growth substrate 100 is not limited and can be selected according to need. In one embodiment, the growth substrate 100 is a copper sheet. In one embodiment, in order to make the graphene 200 more flat without wrinkles, the growth substrate 100 is hydrophilic treated. The method for hydrophilic treating the growth substrate 100 includes the steps: cleaning the growth substrate 100 using an ultra clean standard; and than treating the growth substrate 100 with microwave plasma.

The method for growing the graphene 200 on the growth substrate 100 is not limited. In one embodiment, the method for growing the graphene 200 on the growth substrate 100 includes the following steps:

S111, depositing a catalyst layer on the growth substrate 100; and

S112, placing the growth substrate 100 with the catalyst layer in a chamber, supplying the carbon source gas into the chamber, and heating the growth substrate 100, thereby forming the graphene 200 on the growth substrate 100.

During step S111, a metal or metal compound material is deposited on the surface of the growth substrate 100 to form the catalyst layer. The metal can be one of gold, silver, copper, iron, cobalt and nickel, or any combination thereof. The metal compound may be one of zinc sulfide, zinc oxide, iron nitrate, iron chloride, copper chloride, or any combination thereof. A method for depositing the catalyst layer on the growth substrate 100 is not limited, such as chemical vapor deposition, physical vapor deposition, vacuum thermal evaporation, magnetron sputtering, plasma enhanced chemical vapor deposition, or printing.

During step S112, the chamber can provide a reaction space for growing the graphene 200. The chamber can have a sealed cavity. The chamber includes a gas inlet and a gas outlet. The gas inlet is used to input a reaction gas or other resource gas. The gas outlet is connected with an evacuating device. The evacuating device can be used to adjust the pressure in the chamber. Furthermore, the chamber can include a water cooling device to adjust the temperature in the chamber. The chamber can be a quartz tube furnace.

The chamber is evacuated before heating the growth substrate 100. In one embodiment, hydrogen gas can be introduced in the chamber through the gas inlet before heating the growth substrate 100. The hydrogen gas can prevent the growth substrate 100 from oxidizing. The carbon source gas can be at least one of methane, ethane, ethylene, or acetylene. A flow rate of the carbon source gas can be in a range of about 20 standard cubic centimeters per minute (sccm) to about 90 sccm. The chamber is heated to a heating temperature can be in a range of about 800 degrees Celsius to about 1000 degrees Celsius. The chamber is held at the heating temperature for a constant temperature period for about 10 minutes to about 60 minutes. A ratio between the flow rate of the carbon source gas and the hydrogen gas is in a range of about 45:2 to about 15:2. A pressure in the chamber can be in a range of about 10⁻¹ Pa to about 10² Pa. In one embodiment, the pressure of the chamber is about 500 mTorr, the temperature of the chamber is about 1000 degrees Celsius, the flow rate of the carbon source gas is about 25 sccm, the carbon gas is methane, and the constant temperature period is about 30 minutes.

During step S12, the material of the adhesive layer 300 is, but not limited to, polymethyl methacrylate (PMMA), heat release tape, or polyvinyl acetal. The polyvinyl acetal includes polyvinyl formal (PVF), polyvinyl butyral (PVB), or the like. The method for placing the adhesive layer 300 is, but not limited to, spin coating or deposition. The thickness of the adhesive layer 300 is not limited. About 150 nanometers to about 2 microns thick PMMA is spun on the surface of the graphene 200 away from the growth substrate 100. And then PMMA is heated at a temperature of about 60 degrees Celsius to about 200 degrees Celsius for about 1 minute to about 10 minutes, to form an adhesive/graphene/growth substrate composite structure. In one embodiment, the adhesive/graphene/growth substrate composite structure is formed by spinning PMMA layer with a thickness in a range from about 150 nanometers to about 2 microns on the surface of the graphene 200 away from the growth substrate 100, and then keeping the PMMA layer at room temperature for about 30 minutes to about 60 minutes. In one embodiment, PMMA layer of about 200 nanometers thickness is spun on the surface of the graphene 200 away from the growth substrate 100, and the PMMA layer is heated at a temperature of about 180 degrees Celsius for about 2 minutes, to form the adhesive/graphene/growth substrate composite structure. The adhesive/graphene/growth substrate composite structure includes the adhesive layer 300, the graphene 200, and the growth substrate 100. The graphene 200 is between the growth substrate 100 and the adhesive layer 300. The graphene 200 includes a first surface and a second surface opposite to the first surface, the first surface is in direct contact with the growth substrate 100, and the second surface is in direct contact with the adhesive layer 300.

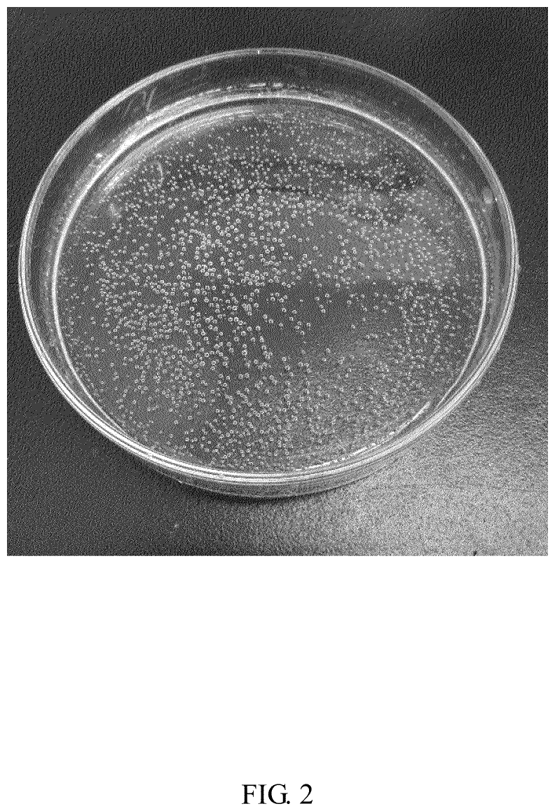

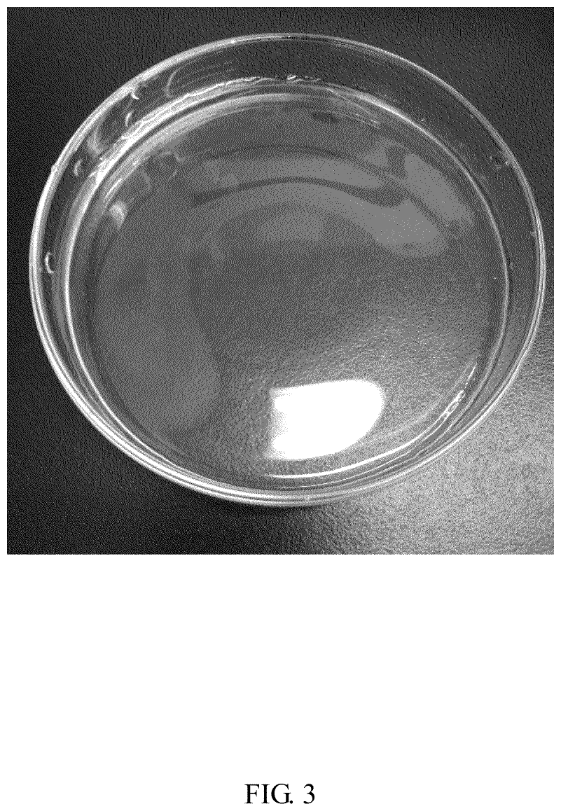

During step S13, the etching solution 600 is a mixture of hydrogen peroxide (H₂O₂), hydrochloric acid (HCL), and deionized water (DIW). The hydrogen peroxide is mainly used to oxidize copper, and the hydrochloric acid is mainly used to maintain an acidic environment. The volume ratio of the hydrogen peroxide, the hydrochloric acid, and the deionized water is: H₂O₂:HCL:DIW=1:1-5:30-100. In one embodiment, the volume ratio of the hydrogen peroxide, the hydrochloric acid, and the deionized water is: H₂O₂:HCL:DIW=1:1:50. A small amount of air bubbles may be present in the etching solution 600, as shown in FIG. 2. The air bubbles of the etching solution 600 may affect the corrosion rate of the etching solution 600. Diluting the etching solution 600 can reduce the air bubbles. When the volume ratio of the hydrogen peroxide, the hydrochloric acid, and the deionized water is: H₂O₂:HCL:DIW=1:1:50, the etching solution 600 has almost no air bubbles. In addition, in order to increase the corrosion rate of the etching solution 600, the air bubbles of the etching solution 600 can be driven away or removed by using a dropper. In one embodiment, no air bubbles exist in the etching solution 600, as shown in FIG. 3. In the process of preparing the etching solution 600, the mixing order of the hydrogen peroxide, the hydrochloric acid, and the deionized water is not limited.

In one embodiment, the volume ratio of the hydrogen peroxide to the hydrochloric acid is 1:1. The volume ratio of the hydrogen peroxide to the deionized water should not be greater than or equal to 1:20, and the volume ratio of the hydrochloric acid to the deionized water should not be greater than or equal to 1:20. When the volume ratio of the hydrogen peroxide to the deionized water is greater than or equal to 1:20, and the volume ratio of the hydrochloric acid to the deionized water is greater than or equal to 1:20, during etching the copper growth substrate 100 with the etching solution 600, the vigorous chemical reactions between the etching solution 600 and the copper can produce a large number of air bubbles. The air bubbles may destroy the structural integrity of the graphene 200, thus the graphene 200 may be broken.

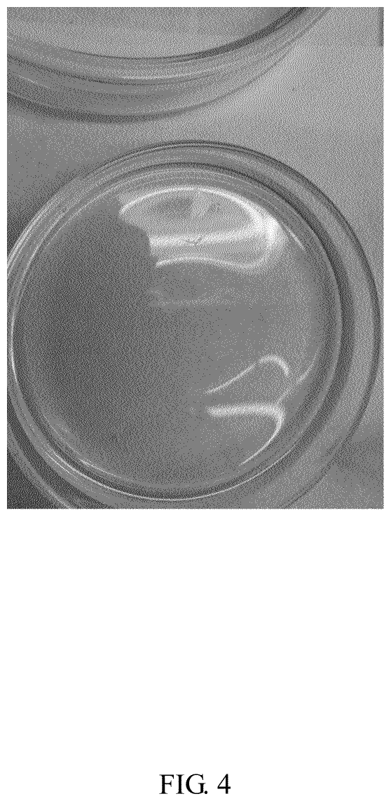

The graphene/adhesive composite structure shown in FIG. 4 is formed by etching the growth substrate 100 using a mixed solution; the mixed solution consists of the hydrogen peroxide, the hydrochloric acid, and the deionized water; and H₂O₂:HCL:DIW (volume ratio)=1:1:20. Seen from FIG. 4, the graphene/adhesive composite structure (the composite structure of the graphene 200 and the adhesive layer 300) is broken, and not an integrated film-like structure.

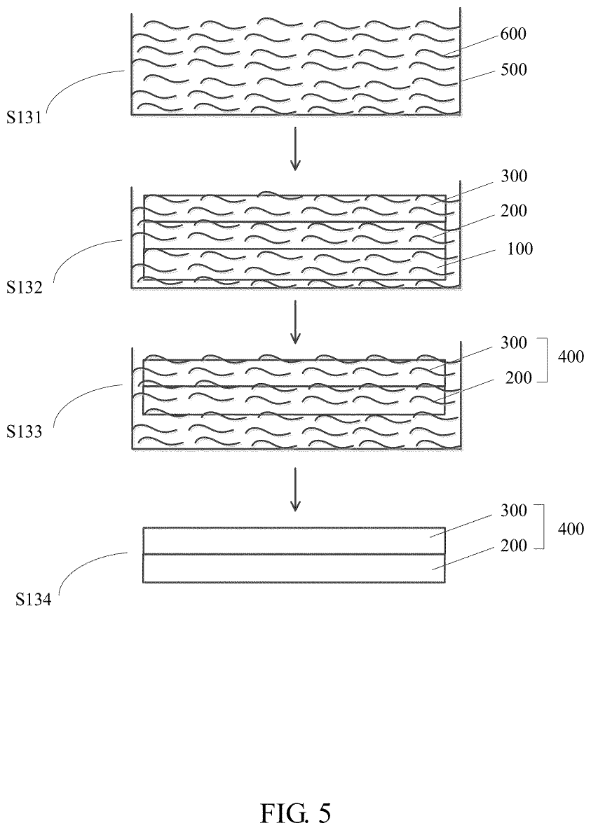

FIG. 5 shows a method for removing the growth substrate 100 with the etching solution 600, and the method includes one or more of the following steps:

S131, pouring the etching solution 600 into an open container 500;

S132, placing the adhesive/graphene/growth substrate composite structure of the step S12 in the etching solution 600, wherein the adhesive layer 300 faces the opening of the container 500, and the growth substrate 100 faces the bottom surface of the container 500 and the growth substrate is immersed in the etching solution 600;

S133, keeping the adhesive/graphene/growth substrate composite structure in the etching solution 600 until the growth substrate 100 is completely etched, leaving the graphene adhesive film 400 floating on the surface of the etching solution 600; and

S134, removing the graphene adhesive film 400 from the etching solution 600.

During step S132, in one embodiment, the adhesive/graphene/growth substrate composite structure is suspended in the etching solution 600.

During step S133, the graphene adhesive film 400 is the composite structure of the graphene 200 and the adhesive layer 300.

After the graphene adhesive film 400 is removed from the etching solution 600, the method for removing the growth substrate 100 further comprises washing graphene adhesive film 400 several times with deionized water and then naturally drying the graphene adhesive film 400. Thus, the graphene adhesive film 400 is free standing and easy to carry.

The graphene adhesive film 400 includes the graphene 200 and the adhesive layer 300 stacked on each other. The graphene 200 is in direct contact with the adhesive layer 300. The adhesive layer 300 is used to support and protect the graphene 200. The graphene adhesive film 400 is a flexible free-standing film. In one embodiment, the graphene adhesive film 400 consists of the graphene 200 and the adhesive layer 300.

The method for making the graphene adhesive film 400 has the following characteristics: 1) the copper growth substrate 100 is etched by the etching solution 600, so that no particles such as iron oxide and copper oxide remain in the graphene 200, thus a pure graphene 200 can be obtained; 2) the adhesive layer 300 has good adhesion and is chemically stable, thus the graphene adhesive film 400 is free-standing and can be directly stored in a clean storage box for subsequent use; 3) the graphene adhesive film 400 is a free-standing film, so that the graphene adhesive film 400 can be cut into arbitrary shape; 4) the graphene adhesive film 400 can be directly attach to the target substrate, and then the adhesive layer 300 can be removed with an organic solvent, thus large-area transferring the graphene 200 can be achieved.

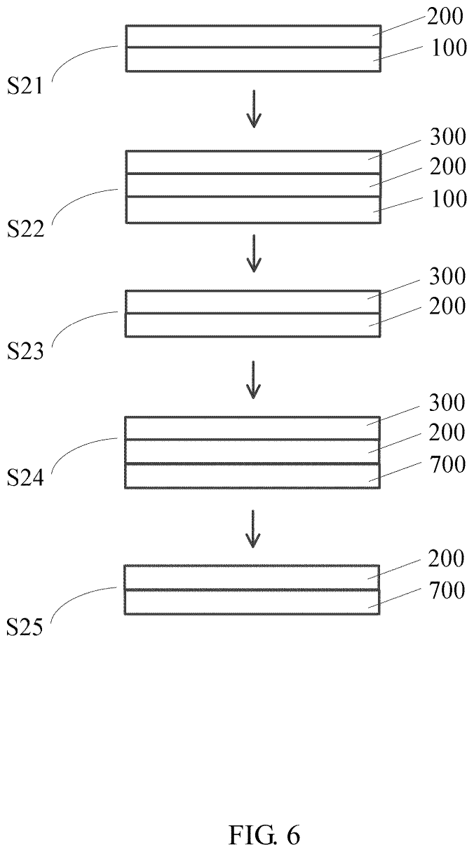

FIG. 6 shows a method for transferring the graphene 200 of a second embodiment, and the method includes one or more of the following steps:

S21, growing the graphene 200 on the growth substrate 100;

S22, placing the adhesive layer 300 on the surface of the graphene 200 away from the growth substrate 100, to form the adhesive/graphene/growth substrate composite structure;

S23, removing the growth substrate 100 with the etching solution 600, to form an adhesive/graphene composite structure;

S24, positioning the adhesive/graphene composite structure on a target substrate 700, wherein the graphene 200 is in direct contact with the target substrate 700; and

S25, removing the adhesive layer 300.

The steps S21, S22, S23 of the second embodiment are the same as the steps S11, S12, S13 of the first embodiment.

During step S24, the graphene 200 is between the target substrate 700 and the adhesive layer 300, the adhesive layer 300 is away from the target substrate 700.

During step S25, the adhesive layer 300 is removed by an organic solvent. The organic solvent is, but not limited to, acetone, ethanol, or the like. In one embodiment, the material of the adhesive layer 300 is PMMA; the etching solution 600 consists of the hydrogen peroxide, the hydrochloric acid, and the deionized water; and H₂O₂:HCL:DIW (volume ratio)=1:1:50.

Furthermore, a comparative embodiment is provided. In the comparative embodiment, PMMA layer is used as the adhesive film, and the ferric chloride solution is used to etch the copper growth substrate 100.

The comparative embodiment is similar to the method for transferring the graphene 200 of the second embodiment above except that the solutions of etching the copper growth substrate 100 are different from each other. In the comparative embodiment, the solution of etching the copper growth substrate 100 is the conventional ferric chloride solution. However, in the method for transferring the graphene 200 of the second embodiment, the solution of etching the copper growth substrate 100 is the etching solution 600 consisting of the hydrogen peroxide, the hydrochloric acid, and the deionized water; and H₂O₂:HCL:DIW (volume ratio)=1:1-5:30-100.

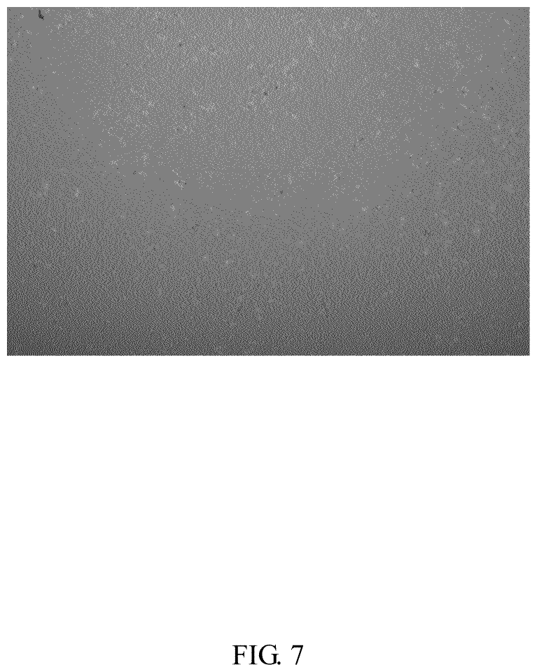

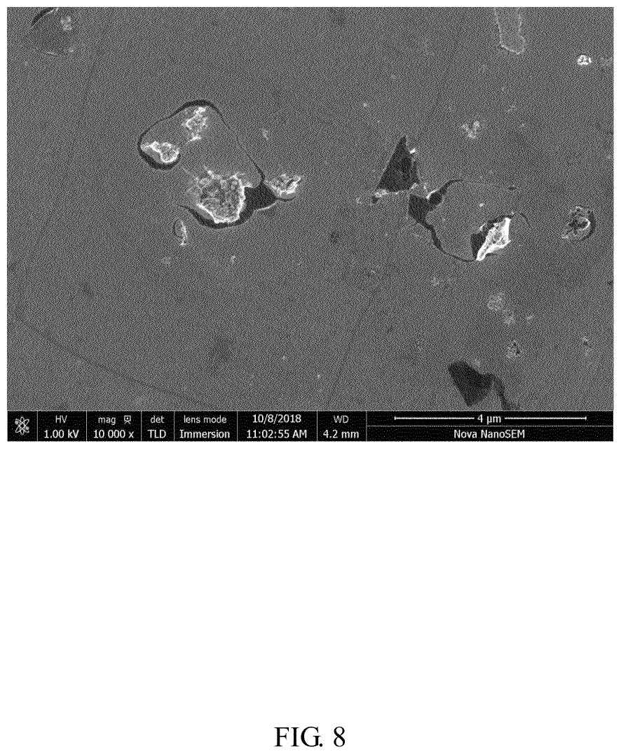

FIG. 7 shows an optical image of the graphene after etching with the ferric chloride solution in the comparative embodiment. In the optical image of FIG. 7, the black spots are residual iron oxide particles or copper oxide particles, and the bright spots are residual PMMA glue. FIG. 8 shows a scanning electron microscope (SEM) image of the graphene after etching with the ferric chloride solution in the comparative embodiment. Seen from FIG. 8, there are granular objects and cracks, which are residual iron oxide particles or copper oxide particles. Thus, when the copper growth substrate 100 is etched by the ferric chloride solution, a large amount of metal oxide particles and PMMA glue remain on the graphene 200, and the structure of the graphene 200 is destroyed.

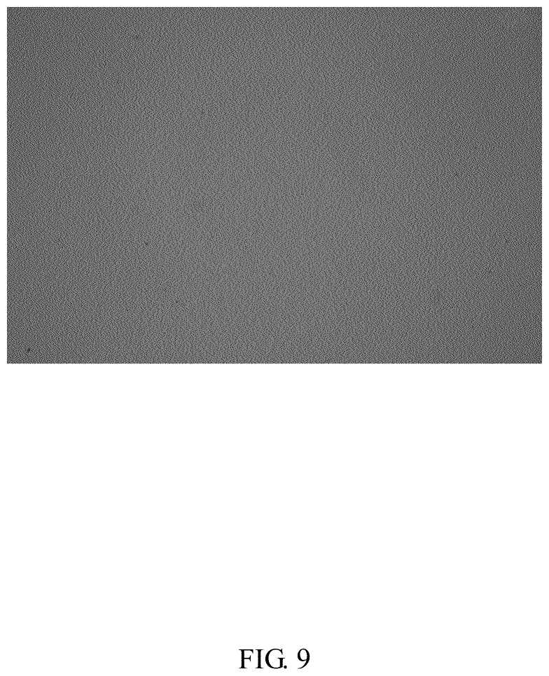

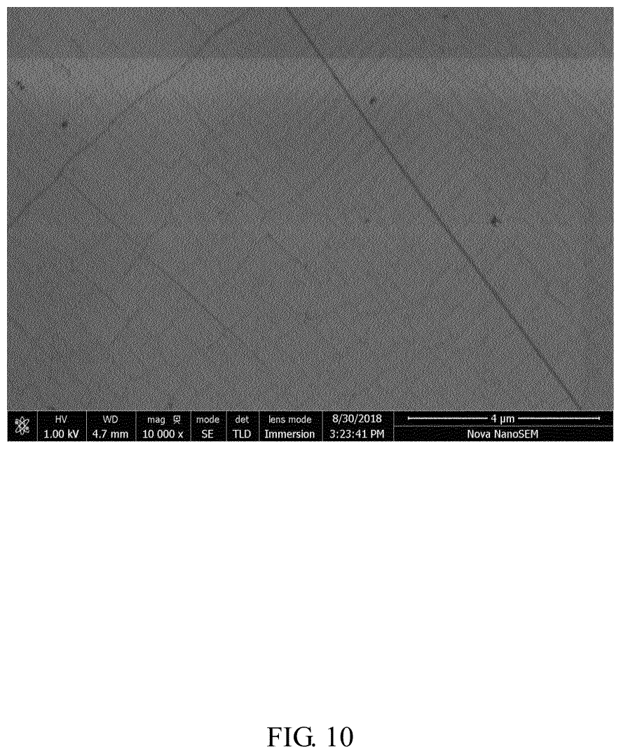

FIG. 9 shows the optical image of the graphene 200 after etching with the etching solution 600 consisting of the hydrogen peroxide, the hydrochloric acid, and the deionized water, and H₂O₂:HCL:DIW (volume ratio)=1:1:50. In FIG. 9, there are almost no bright spots, and the black spots are greatly reduced. FIG. 10 shows the SEM image of the graphene 200 after etching with the etching solution 600 consisting of the hydrogen peroxide, the hydrochloric acid, and the deionized water, and H₂O₂:HCL:DIW (volume ratio)=1:1:50. As shown in FIG. 10, the graphene 200 has a complete structure and is not destroyed, and there are no granular objects. Thus, when the copper growth substrate 100 is etched by the etching solution 600, there are almost no metal oxide particles and PMMA glue on the graphene 200.

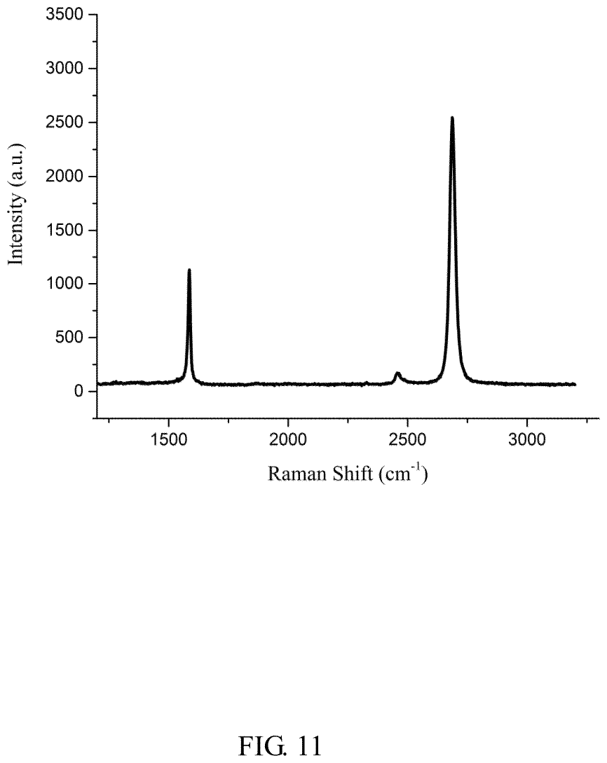

FIG. 11 shows a Raman spectrum of the graphene 200 after etching with the etching solution 600 consisting of the hydrogen peroxide, the hydrochloric acid, and the deionized water, and H₂O₂:HCL:DIW (volume ratio)=1:1:50. Seen from FIG. 11, there is no D peak at all in the Raman spectrum, indicating that the etching solution 600 does not cause damage to the graphene 200, and defects are not introduced into the graphene 200. Furthermore, the adhesive layer 300 can be completely removed by annealing. The annealing temperature can be selected according to the material of the adhesive layer 300.

The method for transferring the graphene 200 has the following characteristics: 1) the copper growth substrate 100 is etched with the etching solution 600, so that no particles such as iron oxide and copper oxide exist in the graphene 200, thus a pure graphene 200 can be obtained; 2) the method is simple and easy.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may comprise some indication in reference to certain steps. However, the indication used is only to be viewed for identification purposes and not as a suggestion as to an order for the steps.

1. A method for making a graphene adhesive film, and the method comprising:
growing a graphene on a growth substrate, wherein the growth substrate is a copper sheet;
depositing an adhesive layer on a surface of the graphene away from the growth substrate, to form an adhesive/graphene/growth substrate composite structure; and
removing the growth substrate from the adhesive/graphene/growth substrate composite structure by etching the growth substrate by an etching solution, wherein the etching solution is a mixture of hydrogen peroxide, hydrochloric acid, and deionized water; and a volume ratio of the hydrogen peroxide (H₂O₂), the hydrochloric acid (HCL), and the deionized water (DIW) is about: H₂O₂:HCL:DIW=1:1:50.

2-3. (canceled)

4. The method of claim 1, wherein the method of removing the growth substrate from the adhesive/graphene/growth substrate composite structure comprises:
placing the etching solution in a container comprising an opening and a bottom surface, wherein the opening is opposite to the bottom surface;
placing the adhesive/graphene/growth substrate composite structure in the etching solution, wherein the adhesive layer faces the opening of the container, and the growth substrate faces the bottom surface of the container and the growth substrate is immersed in the etching solution;
keeping the adhesive/graphene/growth substrate composite structure in the etching solution until the growth substrate is etched, leaving the graphene with the adhesive layer floating on the etching solution; and
removing the graphene with the adhesive layer from the etching solution.

5. The method of claim 4, wherein the method of placing the adhesive/graphene/growth substrate composite structure in the etching solution is performed by suspending the adhesive/graphene/growth substrate composite structure in the etching solution with the adhesive layer gravitationally facing up.

6. The method of claim 4, wherein the step of removing the growth substrate from the adhesive/graphene/growth substrate composite structure further comprises removing air bubbles in the etching solution before placing the adhesive/graphene/growth substrate composite structure in the etching solution.

7. The method of claim 6, wherein the method of removing air bubbles in the etching solution is using a dropper to drive the air bubbles out of the etching solution.

8. A method for transferring a graphene, and the method comprising:
growing a graphene on a growth substrate, wherein the growth substrate is a copper sheet;
depositing an adhesive layer on a surface of the graphene away from the growth substrate, to form an adhesive/graphene/growth substrate composite structure;
removing the growth substrate from the adhesive/graphene/growth substrate composite structure by etching the growth substrate by an etching solution, to form an adhesive/graphene composite structure, wherein the etching solution is a mixture of hydrogen peroxide, hydrochloric acid, and deionized water; and a volume ratio of the hydrogen peroxide (H₂O₇), the hydrochloric acid (HCL), and the deionized water (DIW) is about: H₂O₂:HCL:DIW=1:1:50;
placing the adhesive/graphene composite structure on a target substrate, wherein the graphene is between the target substrate and the adhesive layer; and
removing the adhesive layer.

9-10. (canceled)

11. The method of claim 8, wherein the method of removing the growth substrate from the adhesive/graphene/growth substrate composite structure comprises:
placing the etching solution in a container comprising an opening and a bottom surface, wherein the opening is opposite to the bottom surface;
placing the adhesive/graphene/growth substrate composite structure in the etching solution, wherein the adhesive layer faces the opening of the container, and the growth substrate faces the bottom surface of the container and the growth substrate is immersed in the etching solution;
keeping the adhesive/graphene/growth substrate composite structure in the etching solution until the growth substrate is etched, leaving a graphene with the adhesive film floating on a surface of the etching solution; and
removing the graphene with the adhesive film from the etching solution.

12. The method of claim 11, wherein the method of placing the adhesive/graphene/growth substrate composite structure in the etching solution is performed by suspending the adhesive/graphene/growth substrate composite structure in the etching solution with the adhesive layer gravitationally facing up.

13. The method of claim 11, the method of removing the growth substrate from the adhesive/graphene/growth substrate composite structure further comprises removing air bubbles in the etching solution, before placing the adhesive/graphene/growth substrate composite structure in the etching solution.

14. The method of claim 13, wherein the method of removing air bubbles of the etching solution is using a dropper to drive the air bubbles out of the etching solution.
